(19) United States
(12) Patent Application Publication
(10) Pub. No.: US 2005/0226468 A1
(43) Pub. Date: Oct. 13, 2005

(54) Method and apparatus for enabling context awareness in a wireless system

(75) Inventors: Nikhil M. Deshpande, Beaverton, OR (US); Uttam K. Sengupta, Portland, OR (US); Johnny Chen, Hillsboro, OR (US); John W. Sherry, Portland, OR (US)

Correspondence Address: The Law Offices of John C. Scott, LLC;c/o PortfolioIP, P.O. Box 52050, Minneapolis, MN, 55402, US

(73) Assignee: Intel Corporation

(21) Appl. No.: 10/812,815

(22) Filed: Mar. 30, 2004

(51) Int. Cl. G06K 9/00

(52) U.S. Cl. 382/115; 340/5.8; 455/411

(57) ABSTRACT

Techniques and structures are disclosed for implementing context awareness within a wireless system.

### TECHNICAL FIELD

The invention relates generally to wireless communications and, more particularly, to techniques and structures for implementing context awareness within wireless systems.

### BRIEF DESCRIPTION OF THE DRAWINGS

FIG. 1 is a block diagram illustrating an example wireless arrangement in accordance with an embodiment of the present invention;

FIG. 2 is a flowchart illustrating an example method for use in operating a wireless device in accordance with an embodiment of the present invention;

FIG. 3 is a flowchart illustrating an example method for use in operating a wireless device in accordance with another embodiment of the present invention;

FIG. 4 is a block diagram illustrating an example wireless arrangement in accordance with another embodiment of the present invention; and

FIG. 5 is a flowchart illustrating an example method for use in managing unauthorized use of a wireless device within a network environment in accordance with an embodiment of the present invention.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

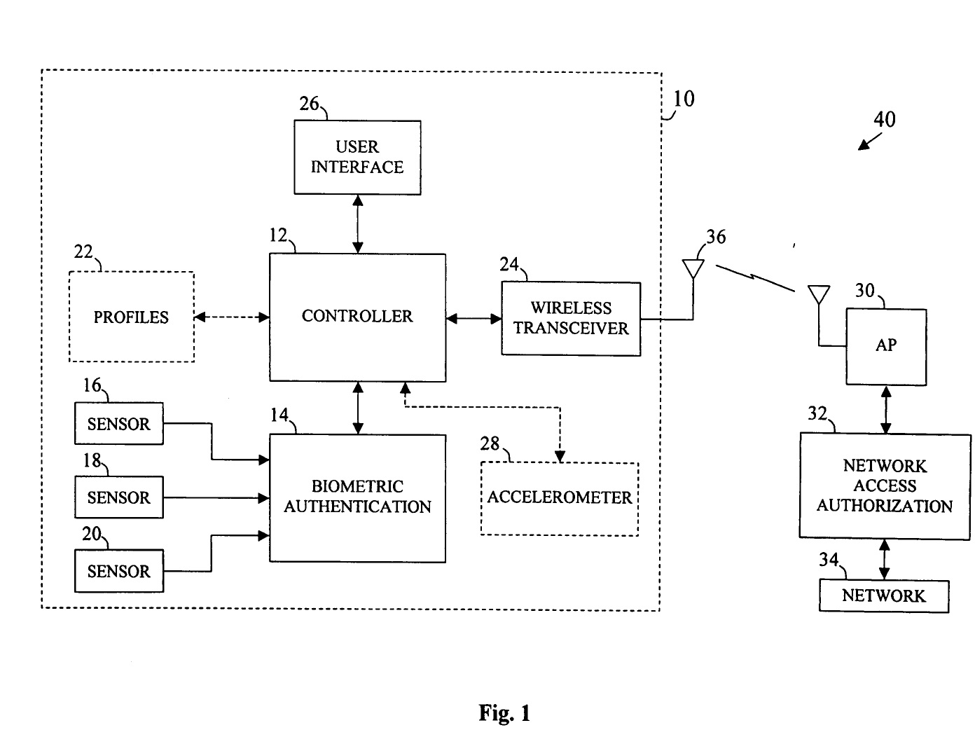

FIG. 1 is a block diagram illustrating an example wireless arrangement 40 in accordance with an embodiment of the present invention. As illustrated, the wireless arrangement 40 includes a wireless device 10 that may communicate with a remote wireless access point (AP) 30 (or other remote wireless entity) via a wireless link. The wireless device 10 may include any form of mobile or portable wireless device or structure that is capable of communicating with a remote network or system including, for example, a cellular telephone or other handheld wireless communicator, a laptop, palmtop, or tablet computer having wireless networking functionality, a personal digital assistant (PDA) having wireless networking functionality, a pager, and/or others. The AP 30 is operative for providing wireless access to a network for one or more wireless devices in a vicinity thereof. In the illustrated embodiment, the AP 30 is coupled to (or includes) a network access authorization unit 32 for use in determining whether to grant the wireless device 10 access to an associated network 34. In a cellular-type communication system application, the AP 30 may represent a cellular base station or the like. The network 34 may include any type of network that a wireless user may desire to access including, for example, a private network, a public network, a wireless network, a wired network, a local area network (LAN), a municipal area network (MAN), a wide area network (WAN), a public switched telephone network (PSTN), the Internet, and/or others, including combinations of the above.

As illustrated in FIG. 1, the wireless device 10 may include one or more of the following: a controller 12, a biometric authentication unit 14, one or more biometric sensors 16, 18, 20, a storage medium for storing user profiles 22, a wireless transceiver 24, a user interface 26, and an accelerometer 28. The controller 12 is operative for controlling the overall operation of the wireless device 10. The controller functionality may be implemented within, for example, one or more digital processing devices. The wireless transceiver 24 is operative for supporting wireless communication with one or more remote wireless entities. In at least one embodiment, the wireless transceiver 24 may be configured in accordance with one or more wireless standards including, for example, one or more wireless cellular standards and/or one or more wireless networking standards. The wireless transceiver 24 may be coupled to one or more antennas 36 to facilitate the transmission and reception of wireless signals. Any type of antenna(s) may be used including, for example, a dipole antenna, a patch antenna, a helical antenna, an antenna array, and/or others. Other types of transducers may alternatively be used (e.g., an infrared (IR) diode in an IR based system, etc.).

The user interface 26 is operative for providing an interface between a user and the device 10. The user interface 26 may include structures such as, for example, a keyboard, a liquid crystal display (LCD), a speaker, a microphone, a mouse, a stylus, and/or any other form of device or structure that allows a user to input information or commands to the device 10 or receive information or responses from the device 10. As will be appreciated, the specific types of input/output devices that are used will depend upon the type of wireless device at issue.

The biometric sensors 16, 18, 20 are sensors that are capable of collecting biometric information from a user that is currently holding the device 10. As used herein, the term “biometric” relates to methods and structures for recognizing a person based on physiological and/or behavioral characteristics. The biometric sensors 16, 18, 20 are therefore capable of measuring such characteristics. The biometric sensors 16, 18, 20 may include, for example, a fingerprint sensor, a skin temperature sensor, a skin texture sensor, a hand geometry sensor, a heartbeat sensor, a retinal scanner, a voice print sensor, a microphone to detect audio cues, a camera or other structure to detect visual cues, and/or others. In at least one embodiment, a biometric sensor may be separate from the wireless device and, therefore, the user does not have to be holding the device to be biometrically authenticated. For example, a user may use a wireless headset (e.g., a Bluetooth headset, etc.) to make a telephone call, without having to hold the telephone itself. The headset can collect voice print information about the user and transmit it back to the telephone for use in user authentication. Many other alternatives also exist.

The biometric authentication unit 14 is operative for determining whether a person currently holding the device 10 is authorized to use the device 10, based on the collected biometric information. The biometric authentication unit 14 may perform this function by, for example, comparing the collected biometric information (or a derivative thereof) to stored information associated with each authorized user. For example, collected fingerprint information may be compared to stored fingerprint information for each authorized user, etc. The biometric authentication unit 14 may require a match for a single type of collected information (e.g., fingerprint only) or for multiple different types of collected information (e.g., fingerprint, skin texture, etc) before determining that a person currently holding the device is a specific authorized user. However, a match may not be required for all available biometric information to make a determination of authenticity. For example, it may only be required that two types of information out of four produce a match to determine that a user is authentic. In at least on embodiment, biometric authentication techniques are combined with one or more conventional authentication techniques (e.g., passwords, input codes, etc.) in order to authenticate a user.

In at least one embodiment of the invention, the functionality for performing the biometric authentication is not located within the wireless device 10 itself. That is, the functionality may be located remote from the device 10 (e.g., within the AP 30, etc.). In such an embodiment, the wireless device 10 may cause the collected biometric information (or a derivative thereof) to be delivered to the external location, via wireless link, for processing. An authentication result may then be received from the external location indicating whether the person currently holding the device 10 is authorized to use the device 10.

In at least one implementation, multiple users may be authorized to use the wireless device 10. In such an implementation, a separate profile may be maintained within the device 10 for each of the authorized users. A user's profile may include, for example, network information, service directories, device input/button configurations (e.g., for different commands), input/output (I/O) preferences (e.g., visual, motion (vibrate), audio preferences), I/O configuration (e.g., screen color, skins, themes, sound cues and themes, etc.), personal data (e.g., phone numbers, references, etc.), and/or other types of information. A storage medium 22 may be provided for use in storing the user profiles. Any type of storage medium may be used including; for example, a semiconductor memory device (e.g., an erasable programmable read only memory (EPROM), an electrically erasable programmable read only memory (EEPROM), a flash memory, etc.), a magnetic disk drive, and/or others. The storage medium 22 may also have other uses within the device 10 in addition to storing profiles. After a person holding the device 10 has been authenticated, the controller 12 may retrieve a profile from the storage medium 22 for use in, for example, tailoring device operation to that user. The profile may, for example, be loaded within a processor memory (e.g., a random access memory).

After a person holding the device 10 has been authenticated by the biometric authentication unit 14, the controller 12 may attempt to access the network 34. In one possible approach, the controller 12 may cause an access request to be transmitted to the AP 30 using the wireless transceiver 24. The access request may include the authenticated identity of the party currently holding the device 10 (or the AP 30 may request this information in a reply message). To determine whether network access should be granted, the AP 30 may utilize the network access authorization unit 32. The network access authorization unit 32 may compare the authenticated identity information received from the device 10 to a list of authorized network users to make the determination. In another possible approach, the wireless device 10 may send the collected biometric information for a person currently holding the device 10 (or a derivative thereof) to the AP 30 for use in network access authorization. The AP 30 may then trigger the network access authorization unit 32 which will compare the collected biometric information to stored user-specific information to determine whether the person is someone that is authorized to use the network 34. After network access has been granted, the device 10 will enable the user currently holding the device 10 to access the network 34.

In some implementations, the network 34 may include multiple different portions and/or services, each requiring independent authorization. In such an embodiment, the network access authorization unit 32 may be configured to individually authorize access to each network portion or service. For a particular user, therefore, access may be granted to some network portions or services and not others. For example, access to a private network portion may be granted while access to the Internet is denied or access to printing services may be granted while access to facsimile services is denied.

In at least one embodiment of the invention, the operational characteristics of a wireless device are made dependent upon whether or not the device is presently being held by a user. That is, when the device is being held by a user, the wireless device may operate in accordance with one group of operational characteristics and, when the device is not being held by a user, the device may operate in accordance with another group of operational characteristics. For example, when a device is picked up, the device may automatically be placed within a normal power mode of operation (e.g., the device may be woken up from a sleep or standby mode, etc.). When the device is placed down, it may automatically be placed in a power save mode of operation (e.g., a sleep mode, a standby mode, etc.). The power save mode may be achieved, for example, by disabling certain functions or components that are normally active within the device. Various stages of low power mode may also exist, with each one being entered, for example, a predetermined period of time after the device is set down. Similarly, when the device is placed down, any user authentications and/or network authorizations that have previously been granted may be dropped.

A grace period may be initiated after a device is placed down before user authentications and/or network authorizations are dropped. For example, if a user has already been authenticated and granted network access and the user temporarily places the wireless device down (to, for example, retrieve a pen to write down a number, etc.), then the connection will still be available when the device is picked back up as long as it is done within a set time period. The length of the grace period may be selected so that situations where an unauthorized user is granted access will be avoided.

Other operational characteristics of a wireless device may also (or alternatively) change based on whether the device is being held. For example, if the device is a cellular telephone, a method of notifying a user of an incoming call may change (e.g., vibration when the device is being held and audible ringing when the device is not being held, etc.). Other changes may also be made.

To determine whether the device 10 is currently being held or not, one or more detection techniques may be used. For example, as shown in FIG. 1, in at least one embodiment of the invention, an accelerometer 28 is provided within the wireless device 10. The accelerometer 28 may track the current physical acceleration of the device 10 and feed this information to the controller 12. The controller 12 may then compare the acceleration information to acceleration profiles known to be associated with the act of picking up the device 10. Other types of acceleration profiles may also be stored within the device 10 for use determining that the device is not being held. For example, if the wireless device is currently within a user's pocket, the device 10 will be subjected to a relatively predictable (e.g., periodic, etc.) form of physical acceleration. If the device is then taken out of the user's pocket and lifted, for example, to the user's ear, another relatively predictable form of acceleration will occur, and so on. In another possible approach for determining whether a device is currently being held, biometric readings from one or more of the biometric sensors 16, 18, 20 may be used. For example, a fingerprint sensor may generate a different output level when a person is touching it than when it is not being touched. Similarly, a skin temperature sensor will output temperature readings in a different range when it is in direct contact with skin than when it is not. In yet another possible approach for determining whether a device is currently being held, some form of electrical measurement may be made that is not necessarily a biometric reading. For example, the electrical reactance of an outer shell of the device 10, or some other portion thereof, may be measured. The reactance may fall within a different range when the device is being held by someone then when it is not being held. Other techniques for determining whether the device 10 is being held may alternatively be used. In at least one approach, multiple different techniques are combined to detect whether the device is being held.

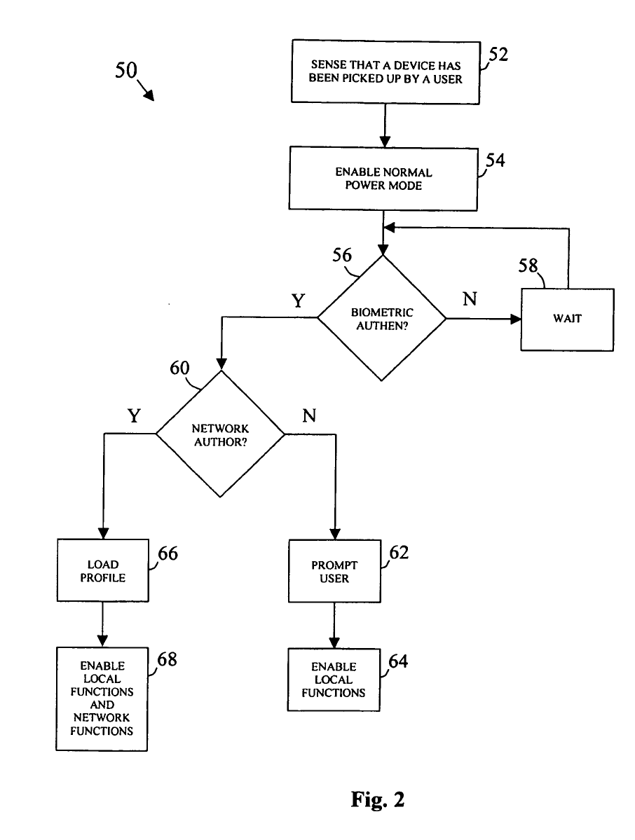

FIG. 2 is a flowchart illustrating an example method 50 for use in operating a wireless device in accordance with an embodiment of the present invention. The method 50 is initiated when it is sensed that the wireless device has been picked up by a user (block 52). Any method may be used to determine that the device has been picked up (including those described above). A normal power mode of the device is then enabled (block 54). While the device was not being held, the device may have been within a power save mode that removed or reduced power to one or more components (e.g., a wireless transmitter, a wireless receiver, an LCD display, etc.) within the device. When the normal power mode is enabled, normal operational power may be restored to some or all of these components. Biometric authentication of the user holding the device may also be performed at this time to determine whether the user holding the device is a person that is authorized to use the device (block 56). If the biometric authentication fails, the device may wait a predetermined period of time (block 58) and then attempt to authenticate the user again. This may be repeated until the user currently holding the device is authenticated or the device is put down by the user. The device may also deactivate some or all user functions at this time (if they haven't been deactivated already).

If the biometric authentication is successful, it is next determined whether the user currently holding the wireless device is authorized to use a network (block 60). The network may be any network that is within range of the wireless device. A network access authorization function may be consulted to determine whether the biometrically identified user has rights to use the network. If the network authorization procedure fails, the user may be prompted (e.g., paged, etc.) to indicate same (block 62). Instructions may also be given to the user at this time to indicate what needs to be done to establish or reestablish network access rights. Because the biometric authentication of the user was successful, the user may be granted access to local functions in the device at this time (i.e., functions within the device itself, such as retrieving stored information, performing calculations, etc.) (block 64). In an alternative approach, the local functions may be enabled right after the biometric authentication is deemed successful (e.g., between block 56 and block 60 in FIG. 2). In still another possible approach, the local functions may be enabled as long as the device is being held. However, in at least one embodiment, access is only given to local functions that do not expose sensitive user data, such as contact list, e-mail, calendar, bookmarks, etc. In other embodiments, no local function access (or just emergency functions (e.g., 911)) is granted unless network authorization has been established.

If the network authorization procedure is successful, a user profile that corresponds to the biometrically authenticated user may be loaded into a processor memory within the wireless device (block 66). As discussed previously, this user profile may be used to tailor operation of the device to the corresponding user. In an alternative approach, the profile may be loaded into memory just after the biometric authentication is deemed successful, but before the network authorization process is performed (e.g., between block 56 and block 60 in FIG. 2). In at least one embodiment of the invention, user-specific profiles are not used. If the network authorization procedure is successful, both local functions and network based functions may be enabled in the device for the user (block 68). While the user uses the device, the biometric authentication process may be performed continuously, periodically, or repeatedly. If the authentication fails during this time (e.g., an authorized user hands the device to an unauthorized user, etc.), the local functions and network specific functions may be disabled until the authenticity of the user holding the device is reestablished.

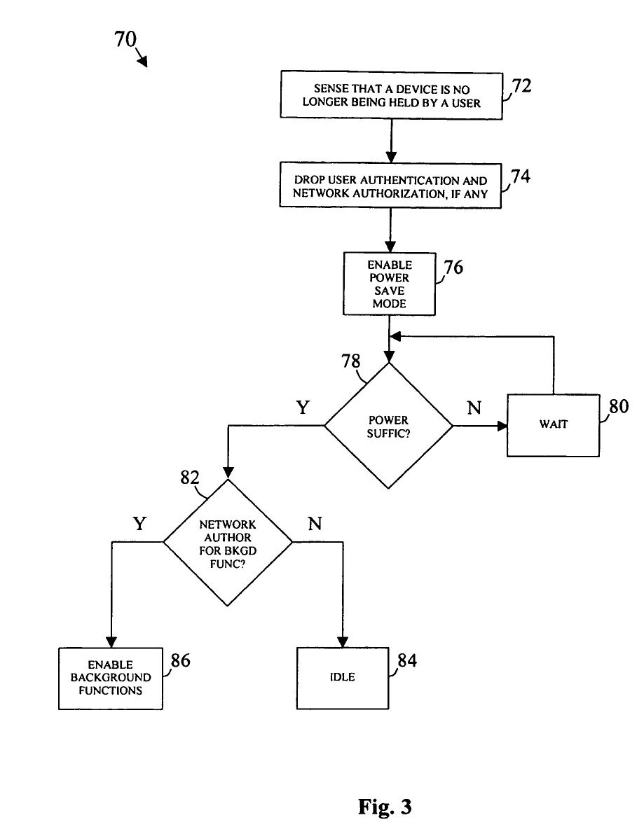

FIG. 3 is a flowchart illustrating an example method 70 for use in operating a wireless device in accordance with an embodiment of the present invention. The method 70 is initiated when it is sensed that the wireless device is no longer being held by a user (block 72). If there has been any previous user authentication and/or network authorization associated with the wireless device, they may be dropped at this time based on the wireless device no longer being held (block 74). Alternatively, the wireless device may wait for a predetermined period of time after sensing that the wireless device is no longer being held to drop the user authentication and network authorization to provide for situations where a user temporarily places a device down and then picks it back up. Also at this time, a power save mode of the wireless device may be enabled (block 76). During power save mode, various components and/or functions of the wireless device may be disabled to reduce power consumption within the device.

It is subsequently determined whether the power level within the device is sufficient for performing one or more back ground functions (block 78). The background functions may include functions such as, for example: performing data backups to a network based storage location, performing synchronization, location based features, remote management, software upgrades, heartbeat, and/or others. Because the device may be operating in power save mode at this point, the available power may not be sufficient for, for example, communicating reliably with a remote access point. If the power level is not sufficient, the device may wait (block 80) and check the power situation again later. The device may, for example, become closer to an access point so that reliable communication can be supported at a present power level. In another possible approach, the power may be temporarily increased to carry out the background functions. If the power is determined to be sufficient, the device may then seek to gain access to the network to perform the background functions (block 82). If the network access authorization procedure fails, the device may then remain idle within the power save mode until it is later picked up by a user (block 84). If the network authorization procedure is successful, on the other hand, the background functions may be enabled and permitted to proceed (block 86).

The method 50 of FIG. 2 and the method 70 of FIG. 3 may be implemented within, for example, the controller 12 of FIG. 1 or within other device controllers. In at least one implementation, a wireless device may switch between the two methods 50, 70 based on the current status of the device (i.e., held or not held). For example, a wireless device may be operating somewhere within the method 50 of FIG. 2 when the wireless device is placed down by the user, thereby initiating the method 70 of FIG. 3. Similarly, the wireless device may be operating somewhere within the method 70 of FIG. 3 when the wireless device is picked up by a user, thereby initiating the method 50 of FIG. 2. As will be appreciated, many alternative operational sequences may also be implemented in accordance with invention.

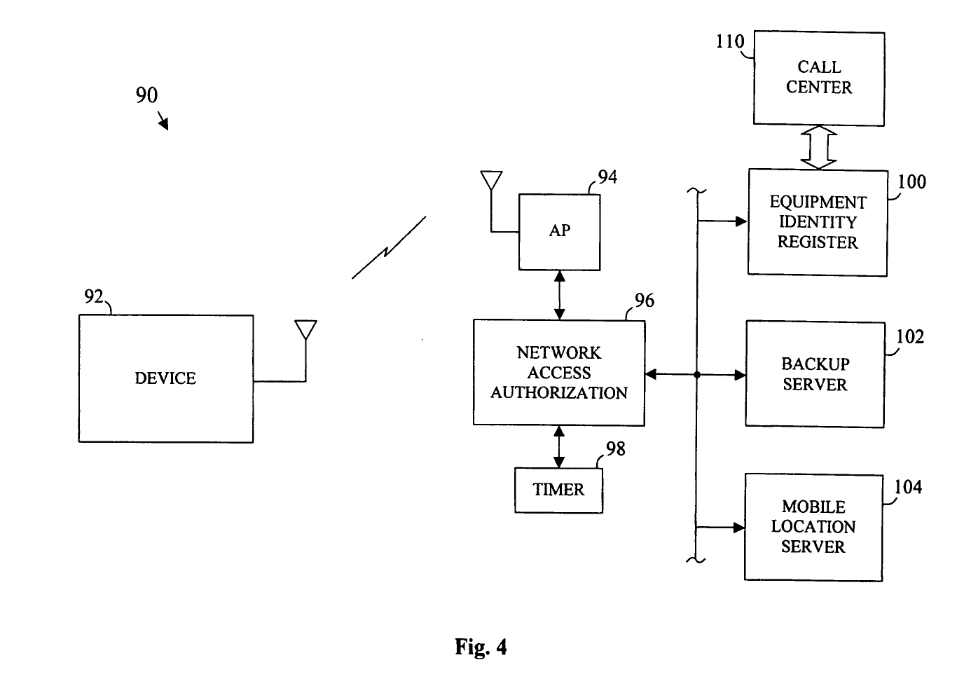

It is not uncommon for a wireless device to be lost or stolen and for an unauthorized party to subsequently attempt to use the device. In at least one aspect of the present invention, techniques and structures are presented for effectively dealing with such circumstances. FIG. 4 is a block diagram illustrating an example wireless arrangement 90 in accordance with an embodiment of the present invention. As illustrated, the wireless arrangement 90 includes a wireless device 92 that may communicate with a remote wireless access point (AP) 94 (or other wireless entity) via wireless link. The wireless device 92 may be similar to, or the same as, the wireless device 10 of FIG. 1. The AP 94 is coupled to, or includes, a network access authorization unit 96 for use in determining whether to grant the wireless device 92 access to an associated network. Various techniques for determining whether to grant network access to a wireless device, including techniques that involve biometric authentication, have been discussed previously. Other techniques may alternatively be used. The network access authorization unit 96 may have access to a timer 98 for use in timing certain activities of the wireless device 92.

The network access authorization unit 96 may also have access to an equipment identity register (EIR) 100, a backup server 102, and/or a mobile location server 104. The EIR 100 is a storage space within a network where a list of the identities of devices that have been reported lost or stolen is maintained. When a user believes that their wireless device has been lost or stolen, the user may contact a call center 110 to report the missing device. The call center 110 will then update the EIR 100 with the identity of the reported device. The network access authorization unit 96 may consult the EIR 100 during the network access authorization process for a wireless device to make sure that the device has not been reported missing. The backup server 102 is operative for managing the backup of data from one or more wireless devices to a network based storage location. The mobile location server 104 is operative for tracking the physical locations of wireless devices within an associated system. The mobile location server 104 may be consulted by the network access authorization unit 96 to determine a current (or relatively recent) location of a device of interest.

In at least one embodiment of the invention, after it has been determined that a particular wireless device has been reported lost or stolen, the network access authorization unit 96 may attempt to determine a physical location of the wireless device (by consulting, for example, the mobile location server 104, etc.). If the wireless device is not located in an expected location (e.g., at the associated user's home, at the associated user's business, etc.), then the backup server 102 may be instructed to perform a data backup of information stored on the wireless device. A data destruct signal may then be delivered to the device to destroy the data on the device to prevent unauthorized parties from accessing the data. If the wireless device is located in an expected location, on the other hand, the device may simply be disabled without destroying the data. Reactivation instructions may also be delivered to the user (e.g., via page, email, etc.) to inform the user how to reactivate the wireless device once it has been found. In addition, in at least one approach, the user may be notified as to the location of the device as determined above (e.g., via email, etc.).

The network access authorization unit 96 may be programmed to rescind network access for the wireless device 92 (assuming it has already been granted) when it is determined that the device 92 is no longer being held by a user. The device 92 may, for example, detect that it has been placed down and send a signal to the network access authorization unit 96 (or some other network entity) indicating same. In at least one implementation, the network access authorization unit 96 will wait a predetermined amount of time after receiving notice that the wireless device 92 has been placed down, to rescind network access. If the wireless device 92 is picked up within that time period, the network access authorization unit 96 may refrain from rescinding network access for the wireless device 92. The network access authorization unit 96 may use the timer 98 to time this activity.

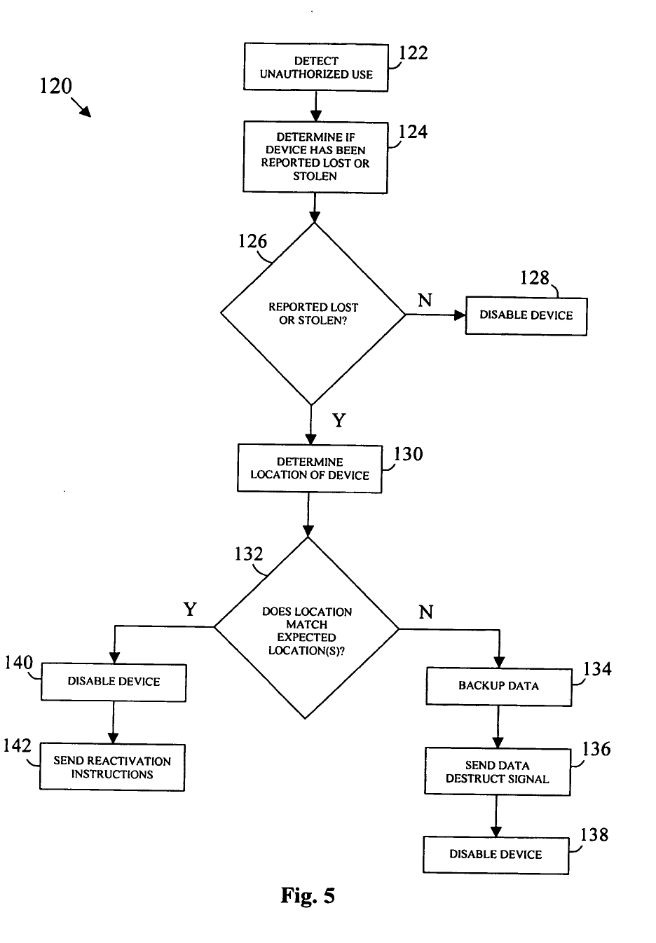

FIG. 5 is a flowchart illustrating an example method 120 for use in managing unauthorized use of a wireless device within a network environment in accordance with an embodiment of the present invention. The method 120 maybe implemented within, for example, the network access authorization unit 96 of FIG. 4 or within other network locations. Unauthorized use of a wireless device is first detected (block 122). The unauthorized use may be detected, for example, by detecting repeated unsuccessful attempts to gain access to a network by the device. Once unauthorized use has been detected, it may be determined whether the device has been reported lost or stolen (block 124). This may be achieved, for example, by consulting an EIR or similar database within the network. If the device has not been reported lost or stolen, the device may simply be disabled (block 128). If the device has been reported lost or stolen, however, a location of the device may then be determined (block 130). In at least one embodiment, a mobile location server is consulted to determine a location of the device. Other means for determining current location may alternatively be used including, for example, using triangulation techniques, consulting a global positioning system (GPS) receiver within the device, etc.

It is next determined whether the location of the wireless device is an expected location. An expected location is a location where a wireless device is likely to be during ordinary use. Expected locations of a device may include, for example, an associated user's home, an associated user's business location, etc.). The authorized user of a device may be asked to supply one or more expected locations of the device during, for example, an account setup process. If the location of the device is not an expected location, data stored on the device may be backed up to a network location (block 134). A data destruct signal may then be sent to the device to destroy some or all of the data stored therein (block 136). The device may then be disabled (block 138). If the location of the device is an expected location, the device may simply be disabled without destroying the data (block 140). The assumption in this case is that the device was simply misplaced, but is still within the control of the authorized user. Reactivation instructions may be delivered to the wireless device or the authorized user to instruct the user how to reactivate the wireless device once it is found (block 142).

The techniques and structures of the present invention may be implemented in any of a variety of different forms. For example, features of the invention may be embodied within cellular telephones and other mobile communicators, pagers, portable computers, PDAs, network interface cards (NICs) and other network interface structures, integrated circuits, wireless access points, network servers, as instructions and/or data structures stored on machine readable media, and/or in other formats. Examples of different types of machine readable media that may be used include floppy diskettes, hard disks, optical disks, CD-ROMs, magneto-optical disks, ROMs, RAMs, EPROMs, EEPROMs, magnet or optical cards, flash memory, and/or other types of media suitable for storing electronic instructions. In at least one form, the invention is embodied as a set of instructions that are modulated onto a carrier wave for transmission over a transmission medium.

It should be appreciated that the individual blocks illustrated in the block diagrams herein may be functional in nature and do not necessarily correspond to discrete hardware elements. For example, with reference to FIG. 1, in at least one embodiment, two or more of the illustrated blocks within the wireless device 10 (e.g., the controller 12 and the biometric authentication unit 14) are implemented in software within a single (or multiple) digital processing device(s). The digital processing device(s) may include, for example, a general purpose microprocessor, a digital signal processor (DSP), a reduced instruction set computer (RISC), a complex instruction set computer (CISC), a field programmable gate array (FPGA), an application specific integrated circuit (ASIC), and/or others, including combinations of the above.

In the foregoing detailed description, various features of the invention are grouped together in one or more individual embodiments for the purpose of streamlining the disclosure. This method of disclosure is not to be interpreted as reflecting an intention that the claimed invention requires more features than are expressly recited in each claim. Rather, as the following claims reflect, inventive aspects may lie in less than all features of each disclosed embodiment.

Although the present invention has been described in conjunction with certain embodiments, it is to be understood that modifications and variations may be resorted to without departing from the spirit and scope of the invention as those skilled in the art readily understand. Such modifications and variations are considered to be within the purview and scope of the invention and the appended claims.

1. A wireless device comprising:
at least one biometric sensor to obtain biometric information about a user presently holding said wireless device when said wireless device is being held;
a biometric authentication unit to determine, based on said biometric information, whether said user presently holding said wireless device is authorized to use said wireless device;
a wireless transceiver to support wireless communication with a remote entity; and
a controller to control operation of said wireless device, wherein said controller is programmed to change operational characteristics of said wireless device based on whether said wireless device is presently being held.

2. The wireless device of claim 1, wherein:
said controller is programmed to request access to a network, using said wireless transceiver, when said wireless device is being held and said biometric authentication unit indicates that said user presently holding said wireless device is authorized to use said wireless device.

3. The wireless device of claim 2, wherein:
said controller includes information identifying said user presently holding said wireless device as part of said request.

4. The wireless device of claim 2, wherein:
said controller includes biometric information obtained by said at least one biometric sensor as part of said request.

5. The wireless device of claim 2, wherein:
said controller is programmed to prompt said user presently holding said wireless device when network access has been denied.

6. The wireless device of claim 1, wherein:
said controller is programmed to deactivate user functions of said wireless device when said wireless device is being held and said biometric authentication unit indicates that said user presently holding said wireless device is not authorized to use said wireless device.

7. The wireless device of claim 1, wherein:
said controller is programmed to place said wireless device in a power save mode when said wireless device is not being held.

8. The wireless device of claim 1, wherein:
said controller is programmed to place said wireless device in a normal power mode when said wireless device is being held.

9. The wireless device of claim 1, further comprising:
a storage medium to store user profiles for multiple authorized users of said wireless device, wherein said controller loads a profile corresponding to said user presently holding said wireless device from said storage medium into a processor memory after said biometric authentication unit indicates that said user presently holding said wireless device is authorized to use said wireless device.

10. The wireless device of claim 1, wherein:
said controller is programmed to request access to a network for use in performing background functions, using said wireless transceiver, when said wireless device is not being held and when power is sufficient to perform said background functions.

11. The wireless device of claim 10, wherein:
said controller is programmed to enable performance of background functions after network access has been obtained.

12. The wireless device of claim 1, further comprising:
an accelerometer to monitor movement of said wireless device, wherein said controller is programmed to use readings of said accelerometer to determine whether said wireless device is currently being held.

13. The wireless device of claim 1, wherein:
said controller is programmed to use readings of said at least one biometric sensor to determine whether said wireless device is currently being held.

14. The wireless device of claim 1, wherein:
said at least one biometric sensor includes at least one of the following: a fingerprint sensor, a skin temperature sensor, a skin texture sensor, a hand geometry sensor, a voice print sensor, and a heartbeat sensor.

15. A method comprising:
sensing that a wireless device has been picked up by a user;
determining, after sensing that said wireless device has been picked up, whether said user is authorized to use said wireless device based on collected biometric information; and
when said user is determined to be authorized to use said wireless device, requesting access to a network via a wireless link.

16. The method of claim 15, further comprising:
enabling a normal power mode of said wireless device after sensing and before determining.

17. The method of claim 15, further comprising:
when said user is determined to not be authorized to use said wireless device, de-activating user functions of said wireless device.

18. The method of claim 15, further comprising:
when said user is determined to be authorized to use said wireless device, loading a profile associated with said user into a processor memory.

19. The method of claim 15, further comprising:
when access to said network has been granted, loading a profile associated with said user into a processor memory.

20. The method of claim 15, further comprising:
when access to said network has been granted, allowing said user to perform network based functions.

21. The method of claim 15, further comprising:
when access to said network has been denied, prompting said user to indicate same.

22. The method of claim 15, further comprising:
when access to said network has been denied, allowing said user to perform local functions, but not network based functions.

23. A method comprising:
sensing that a wireless device is no longer being held by a user; and
dropping user authentication and network authorization for the device, if any, based on said device no longer being held.

24. The method of claim 23, wherein:
dropping user authentication and network authorization includes waiting a predetermined time period after sensing that said wireless device is no longer being held before dropping said user authentication and said network authorization to allow time for a user to pick said wireless device back up.

25. The method of claim 23, further comprising:
activating a power save mode of said wireless device after sensing that said wireless device is no longer being held.

26. The method of claim 23, further comprising:
requesting access to a network for use in performing background functions after sensing that said wireless device is no longer being held.

27. The method of claim 26, further comprising:
waiting for a power level of said wireless device to be sufficient for performing background functions before requesting access to said network.

28. The method of claim 26, further comprising:
allowing background functions to be performed after access to the network has been granted.

29. A method comprising:
detecting unauthorized use of a wireless device;
determining, in response to detecting, whether said wireless device has been reported lost or stolen; and
when said wireless device is determined to have been reported lost or stolen:
determining a location of said wireless device; and
when said location of said wireless device is not an expected location,
backing up data from said wireless device to a remote location.

30. The method of claim 29, further comprising:
sending a data destruct signal to said wireless device to destroy data stored thereon after backing up said data.

31. The method of claim 29, further comprising:
when said location of said wireless device is an expected location, disabling user accessible functions of said wireless device.

32. The method of claim 31, further comprising:
sending reactivation instructions to said wireless device after disabling said user accessible functions of said wireless device.

33. The method of claim 29, further comprising:
when said wireless device is determined to have not been reported lost or stolen, disabling user accessible functions of said wireless device.

34. The method of claim 29, wherein:
determining whether said wireless device has been reported lost or stolen includes consulting a list of devices reported lost or stolen that is maintained at a network location.

35. The method of claim 34, wherein:
consulting a list of devices reported lost or stolen includes consulting an equipment identity register (EIR).

36. The method of claim 29, wherein:
determining a location of said wireless device includes consulting a list of device locations that is maintained at a network location.

37. The method of claim 36, wherein:
consulting a list of device locations includes consulting a mobile location server.

38. A system comprising:
a network access authorization unit to manage network access authorization for wireless devices in a network;
an equipment identity register (EIR) to maintain a list of wireless devices that have been reported lost or stolen, said EIR being accessible by said network access authorization unit;
a backup server to manage data backups for wireless devices in said network; and
a mobile location server (MLS) to track locations of wireless devices in said network;
wherein said network access authorization unit is configured to determine whether a first wireless device has been reported lost or stolen when unauthorized use of said first wireless device has been detected and to determine a location of said first wireless device when it is determined that said first wireless device has been reported lost or stolen.

39. The system of claim 38, wherein:
said network access authorization unit is programmed to instruct the backup server to backup data from said first wireless device when said location of said first wireless device is not an expected location of said first wireless device.

40. The system of claim 39, wherein:
said network access authorization unit is programmed to send a data destruct signal to said first wireless device after said backup server has completed the backup of data from said first wireless device to destroy data stored within said first wireless device.

41. The system of claim 39, wherein:
said expected location includes a home location of a user associated with said first wireless device.

42. The system of claim 39, wherein:
said expected location includes a work location of a user associated with said first wireless device.

43. The system of claim 38, wherein:
said network access authorization unit is programmed to send a disable signal to said first wireless device to disable user accessible functions therein when said location of said first wireless device is an expected location.

44. The system of claim 43, wherein:
said network access authorization unit is programmed to send reactivation instructions to said first wireless device after sending said disable signal.

45. The system of claim 43, wherein:
said network access authorization unit is programmed to: (a) receive a signal from said first wireless device indicating that said first wireless device is no longer being held by a user, (b) start a timer in response to said signal, and (c) deny network access to said first wireless device after said timer has indicated that a predetermined amount of time has passed without said first wireless device being picked up by a user.

46. An article comprising a storage medium having instructions stored thereon that, when executed by a computing platform, operate to:
sense that a wireless device has been picked up by a user;
determine, after sensing that said wireless device has been picked up, whether said user is authorized to use said wireless device based on collected biometric information; and
when said user is determined to be authorized to use said wireless device, request access to a network via a wireless link.

47. The article of claim 46, wherein said storage medium further includes instructions that, when executed by the computing platform, operate to:
enable a normal power mode of said wireless device after sensing and before determining.

48. The article of claim 46, wherein said storage medium further includes instructions that, when executed by the computing platform, operate to:
when said user is determined to not be authorized to use said wireless device, de-activate user functions of said wireless device.

49. The article of claim 46, wherein said storage medium further includes instructions that, when executed by the computing platform, operate to:
when said user is determined to be authorized to use said wireless device, load a profile associated with said user into a processor memory.

50. The article of claim 46, wherein said storage medium further includes instructions that, when executed by the computing platform, operate to:
when access to said network has been granted, load a profile associated with said user into a processor memory.

51. An article comprising a storage medium having instructions stored thereon that, when executed by a computing platform, operate to:
sense that a wireless device is no longer being held by a user; and
drop user authentication and network access for the wireless device, if any, based on said wireless device no longer being held.

52. The article of claim 51, wherein:
to drop user authentication and network access includes to wait a predetermined time period after sensing that said wireless device is no longer being held before dropping user authentication and network access to allow time for the user to pick said wireless device back up.

53. The article of claim 51, wherein said storage medium further includes instructions that, when executed by the computing platform, operate to:
activate a power save mode of said wireless device after sensing that said wireless device is no longer being held.

54. The article of claim 51, wherein said storage medium further includes instructions that, when executed by the computing platform, operate to:
request access to a network for use in performing background functions after sensing that said wireless device is no longer being held.

55. The article of claim 54, wherein said storage medium further includes instructions that, when executed by the computing platform, operate to:
wait for a power level of the device to be sufficient for performing background functions before requesting access to the network.

56. The article of claim 54, wherein said storage medium further includes instructions that, when executed by the computing platform, operate to:
allow background functions to be performed after access to the network has been granted.

57. A wireless device comprising:
at least one biometric sensor to obtain biometric information about a user presently holding said wireless device when said wireless device is being held;
a biometric authentication unit to determine, based on said biometric information, whether said user presently holding said wireless device is authorized to use said wireless device;
a wireless transceiver to support wireless communication with a remote entity;
a controller to control operation of said wireless device, wherein said controller is programmed to change operational characteristics of said wireless device based on whether said wireless device is presently being held; and
at least one dipole antenna coupled to said wireless transceiver to provide a transition to free space.

58. The wireless device of claim 57, wherein:
said controller is programmed to request access to a network, using said wireless transceiver, when said wireless device is being held and said biometric authentication unit indicates that said user presently holding said wireless device is authorized to use said wireless device.

59. The wireless device of claim 57, wherein:
said controller is programmed to place said wireless device in a power save mode when said wireless device is not being held.

60. The wireless device of claim 57, wherein:
said controller is programmed to place said wireless device in a normal power mode when said wireless device is being held.
